(19) United States
(12) Patent Application Publication
(10) Pub. No.: US 2025/0377555 A1
(43) Pub. Date: Dec. 11, 2025

(54) Sunglasses With Removeable Temples

(71) Applicant: Zuhair Samo, Yuma, AZ (US)

(72) Inventor: Zuhair Samo, Yuma, AZ (US)

(21) Appl. No.: 18/734,146

(22) Filed: Jun. 5, 2024

(51) Int. Cl. G02C 5/14; G02C 5/22

(52) U.S. Cl. CPC G02C 5/146; G02C 5/22

(57) ABSTRACT

Eyewear is provided that includes a frame held on the head by removable temple portions, some of which do not reach or otherwise go over the ear. The eyewear may be held on the temple of the wearer's head by two tension devices, one on each side, which are preferably cams, which in some embodiments also are part of connectors used to removeably attach the temple portions of the eyewear onto the frame. In addition, temple extensions are provided that are attached to the eyewear temple portions of frames. The connectors in certain embodiments comprise a push button spring mechanism for attaching and removing the temple portions of the frames.

### FIELD OF THE INVENTION

The invention relates to eyewear such as sunglasses.

### BACKGROUND OF THE INVENTION

Most sunglasses frames, including frames of large sunglasses, rely on form fit of the sunglasses and the frame temples (e.g., the “frame temples” are frame side arm portions that are perpendicular to the sunglasses lenses and often rest on the wearer's ears) that rest on the ears for them to stay on the face. These frames can pinch the wearer's ears due to the frame temples of the sunglasses being too snug and uncomfortable. This can be especially problematic with wearers with wide pupillary distance. Prior art sunglasses available on the market currently, contrary to certain embodiments of this invention, have long frame temples that rest on the ears since they do not have a strong enough spring mechanism that can keep the sunglasses just on the wearer's temples. In addition, some sunglass frames have the wrong size frame temples for a wearer's head. Better sunglasses and other eyewear that overcome these problems are needed.

### SUMMARY OF THE INVENTION

With certain preferred embodiments of this invention, due to the unique and robust tension device (e.g., cams, springs) and mechanism provided, the eyewear such as sunglasses can rest on the wearer's temples with very short frame temples that do not go over or beyond the ears. If, however, longer frame temples are desired, longer temples and also temple extensions (e.g., slip-on frame temple extensions) of different lengths can be added on or taken off.

The sunglasses of these embodiments allow the wearer to have very short frame temples that can rest on the wearer's temples without the need for the frame temples to go over and behind ears. The benefit of this design allows the wearer, especially those individuals with wide pupillary distance, to have sunglasses that do not pinch the wearer's ears due to the frame temples of sunglasses being too snug and uncomfortable.

In addition, the sunglasses of certain of these embodiments allow the wearer to attach different frame temples of different lengths. With these embodiments, the frame temples can be removed and replaced easily, by pushing a button, which disengages a frame temple from the rest of the frame and permits a different one to be attached.

In certain of the most preferred embodiments of this invention, in addition to having the option of having very short frame temples, these sunglasses come with the option of having slip-on frame temple extensions for those individuals that prefer sunglasses with longer frame temples. These longer slip-on frame temple extensions can simply be inserted over, or otherwise attached to, original frame temples to then have the frames fit over the cars as desired. For example, a wearer may want to have their frames fit more securely on some occasions (e.g., active sports). There are no sunglasses that offer actual slip-on frame temple extensions of different sizes that in themselves act as frame temples and not just sleeves.

Highly preferred embodiments of this invention comprise eyewear for a wearer to wear on the wearer's head and a method for holding the eyewear in place. The eyewear comprises (a) two lenses, each lens for one of the wearer's eyes to look through when the eyeglasses are worn, and (b) one frame.

The frame of these embodiments comprises (i) a front portion for holding each of the two lenses in front of the wearer's eyes, the front portion having a left side and a right side, (ii) two removeable temple portions, one temple portion for the left side of the wearer's head and one temple portion for the right side of the wearer's head, each temple portion extending from the front area of the wearer's head to at least in front of the wearer's ear, and each temple portion providing tension against the wearer's head to hold the eyeglasses in place, and (iii) two connectors that are attached to the front portion, wherein one connector is attached to the left side of the front portion and one connector is attached to the right side of the front portion, wherein each connector can be inserted into one of the removeable temple portions to attach the removeable temple portion to the front portion, wherein in some embodiments each connector has a square, round or other shaped button that can be pushed when the connectors are attached to the removeable temple portions to remove the removeable temple portions from the front portion, and wherein the connectors provide tension (e.g., via a cam, via a spring, via another mechanism known to a person of skill in the art that can put tension on the temple portion) to the removeable temple portions against the wearer's head to hold the eyeglasses in place on the wearer's head.

Certain embodiments of this invention comprise a method of holding eyeglasses on a wearer's head, wherein the eyeglasses comprise a right temple portion and a left temple portion that attach to the eyeglasses by a first connector and a second connector. These methods comprise: a) placing the eyeglasses on the wearer's head; and b) applying tension to the temple portions of the eyeglasses to the wearer's head by the first connector that attaches to the right temple portion and the second connector that attaches to the left temple portion, wherein the tension is provided by cams and springs, and the tension is provided to the wearer's head in front of the wearer's ears.

The eyewear of these preferred embodiments may be sunglasses and each of the lens prevents light from damaging and/or discomforting the eyes. The eyewear may also be safety glasses and each of the lens prevents projectiles from damaging and/or discomforting the eyes. The eyewear may also include two or more temple extensions, each temple extension being capable of fitting over each of the removeable temple portions to extend the frame over more of the wearer's temple and head.

### BRIEF DESCRIPTION OF THE DRAWINGS

FIG. 1A-1E is a drawing of an embodiment of this invention that has relatively short temple portions. FIG. 1A shows a top view, FIG. 1B shows a front view, FIG. 1C shows an exploded view of a cam from the top, FIG. 1D shows a side view, and FIG. 1E shows a side view of a connector.

FIG. 2A-2E is a drawing of an embodiment of this invention that has relatively long temple portions. FIG. 2A shows a top view, FIG. 2B shows a front view, FIG. 2C shows an exploded view of a cam from the top, FIG. 2D shows a side view, and FIG. 2E shows a side view of a connector.

FIG. 3A-3E is a drawing of an embodiment of a front frame portion of this invention without the temple portions installed. FIG. 3A shows a front view, FIG. 3B shows an inside view, FIG. 3D shows a top view, FIG. 3D shows a side view, and FIG. 3E shows a perspective view of the front frame portion (without the temple portions installed).

FIG. 4A-4D is a drawing of an embodiment of a left side temple portion of this invention. FIG. 4A shows a left side inside view, FIG. 4B shows a top view, FIG. 4C shows a side view, and FIG. 4D shows a perspective view of a temple portion.

FIG. 5A-5D is a drawing of an embodiment of a right side temple portion of this invention. FIG. 5A shows a right side inside view, FIG. 5B shows a top view, FIG. 5C shows a side view, and FIG. 4D shows a perspective view of the temple portion.

FIG. 6A-6D is a drawing of an embodiment of a left side temple extension of this invention. FIG. 6A shows a left side inside view, FIG. 6B shows a top view, FIG. 6C shows a side view, and FIG. 6D shows a perspective view of a temple extension.

FIG. 7A-7D is a drawing of an embodiment of a right side temple extension of this invention. FIG. 7A shows a right side inside view, FIG. 7B shows a top view, FIG. 7C shows a side view, and FIG. 7D shows a perspective view of the temple extension.

### DETAILED DESCRIPTION OF THE INVENTION

Certain embodiments of this invention solve the problem with having long frame

temples that sometimes cause certain wearers discomfort due to the frame temples causing friction against the ear due to the wearer's head size (e.g., large) or pupillary distance. In these individuals, wearing such eyewear (e.g., sunglasses) causes irritation and discomfort on the ears or around them for being too tight especially after long hours of wear. Prior art sunglasses do not have a tension mechanism strong enough to put enough tension on the sunglasses frames to hold them only on the temples without the frame temples being long enough to reach the ears. With this invention, thanks to this strong and/or adequate tension device (e.g., cams, springs) mechanism, wearers can have very short frame temples if desired, which will only rest against the temples of the wearers.

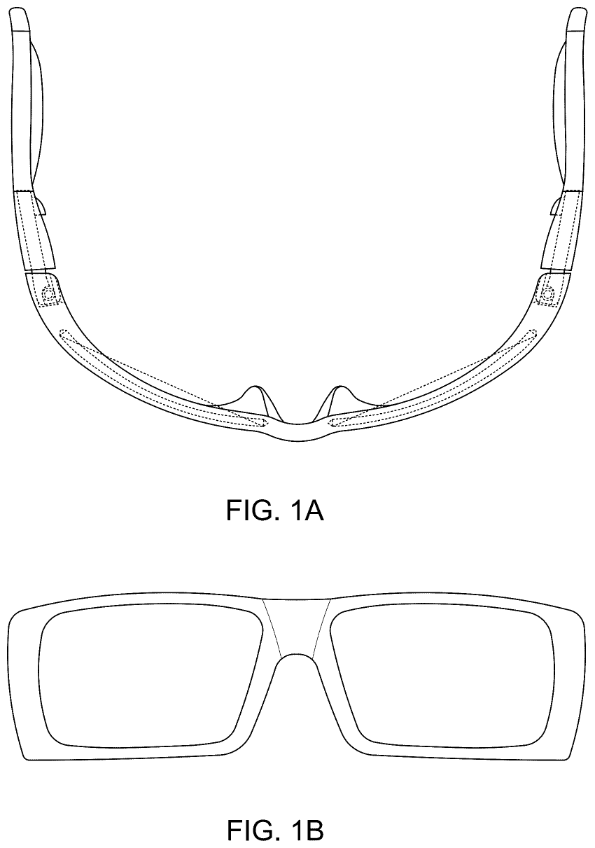

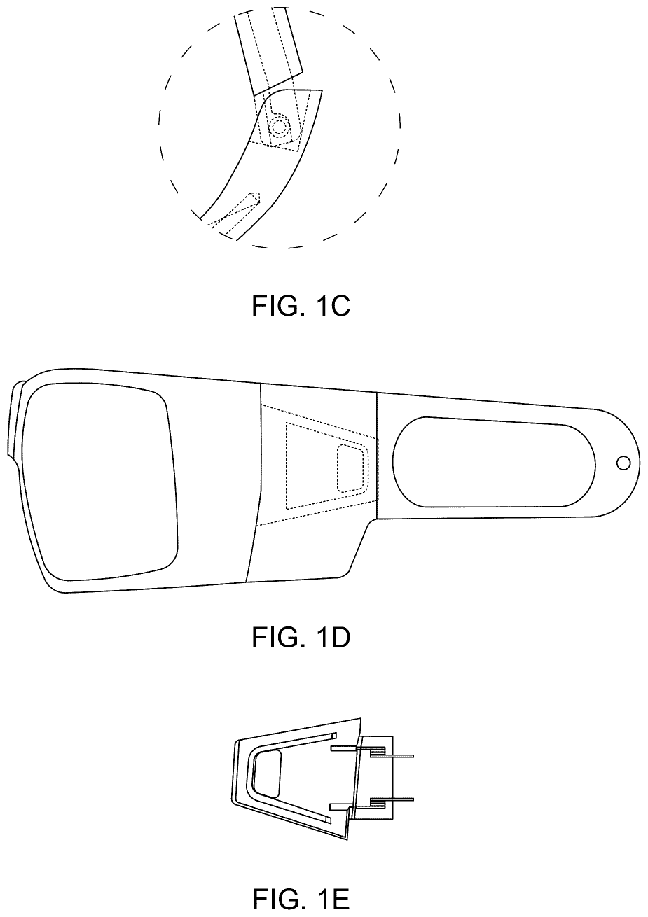

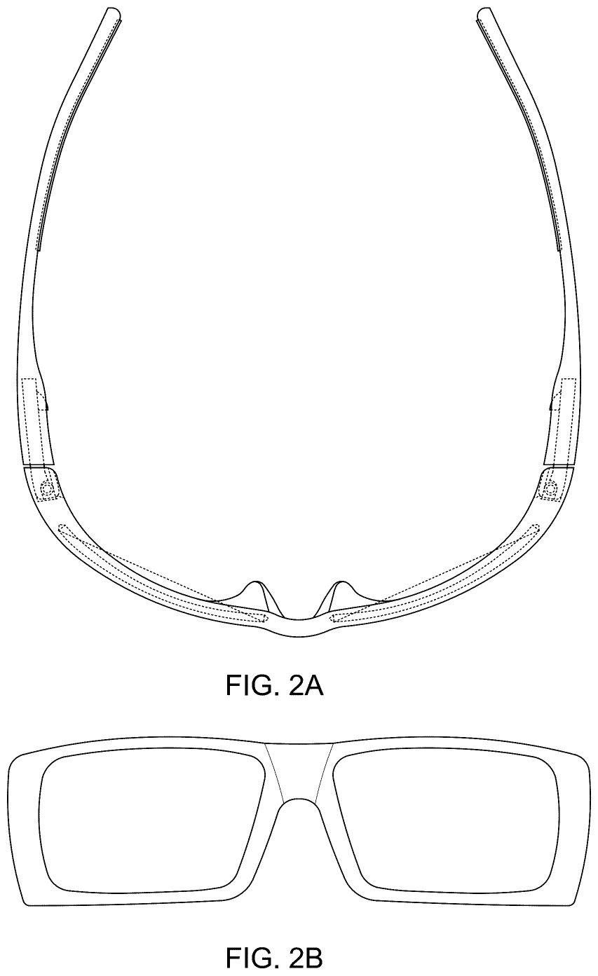

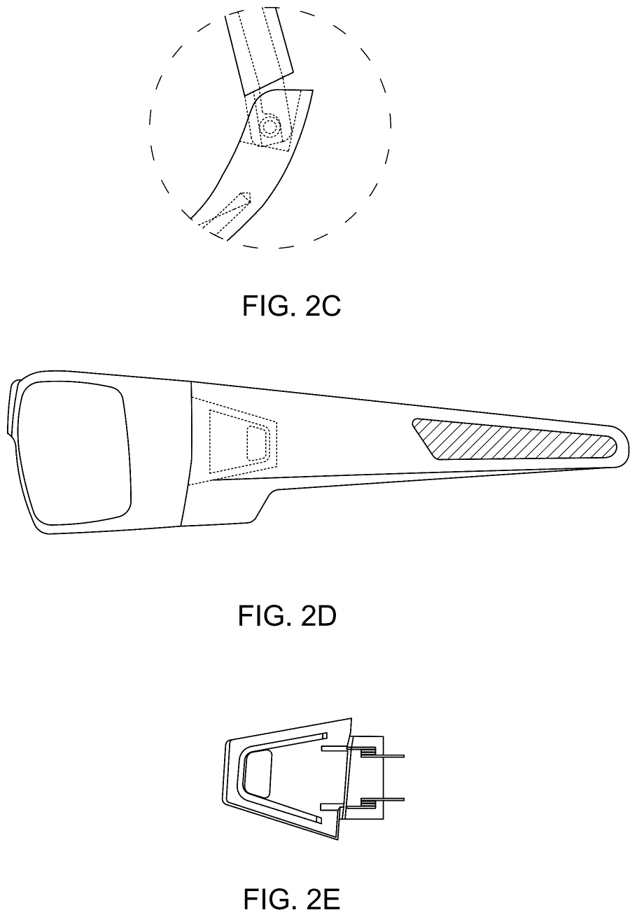

FIGS. 1 and 2 provide drawings of embodiments of eyewear where the tension device comprises a cam, shown in view C of both figures. Other mechanisms used as tension devices will be known to a person of skill in the art, including the use of springs in other configurations. For these FIGS. 1 and 2, A is a top down view of the eyewear, B is a front view of the eyewear, C is an exploded view of the cam mechanism of the eyewear from the top, D is a sideview of the eyewear, and E is a sideview of a connector embodiment of the eyewear. FIG. 1 illustrates a shorter removeable temple portion than the temple portion used in FIG. 2.

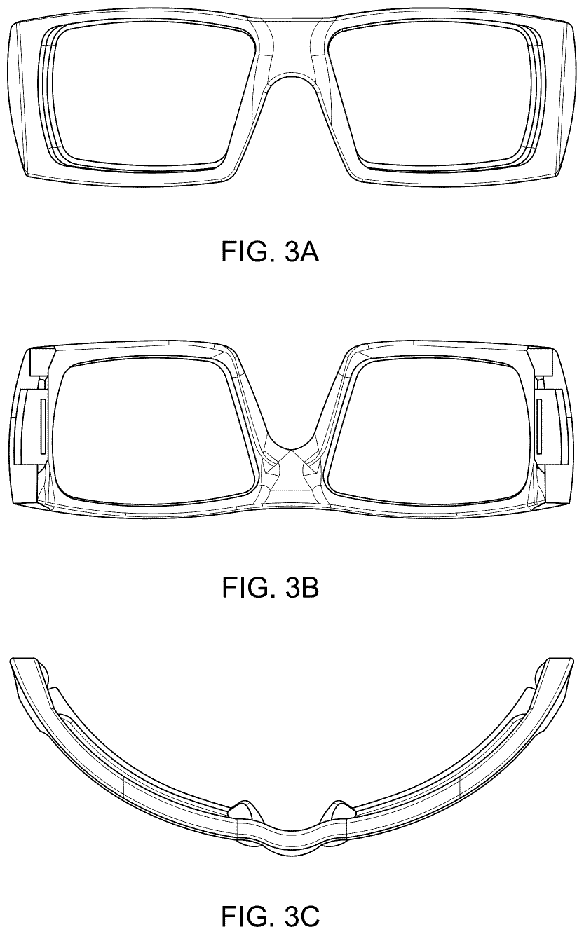

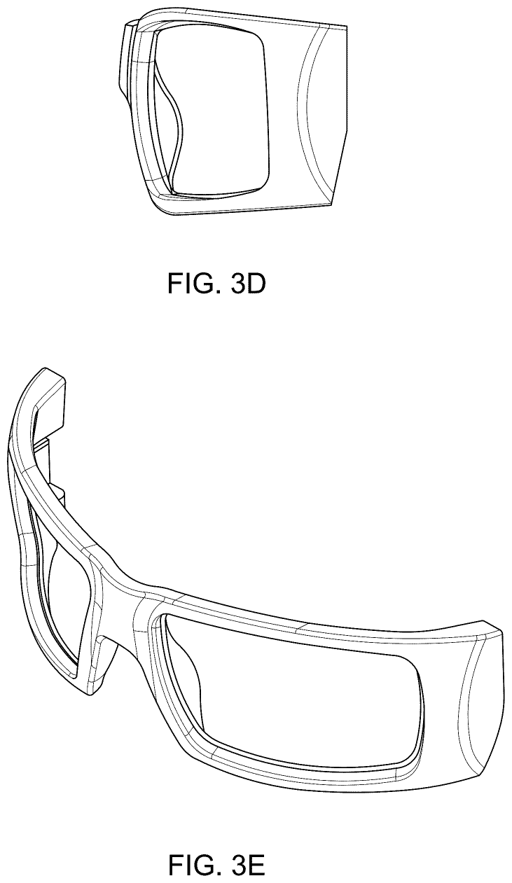

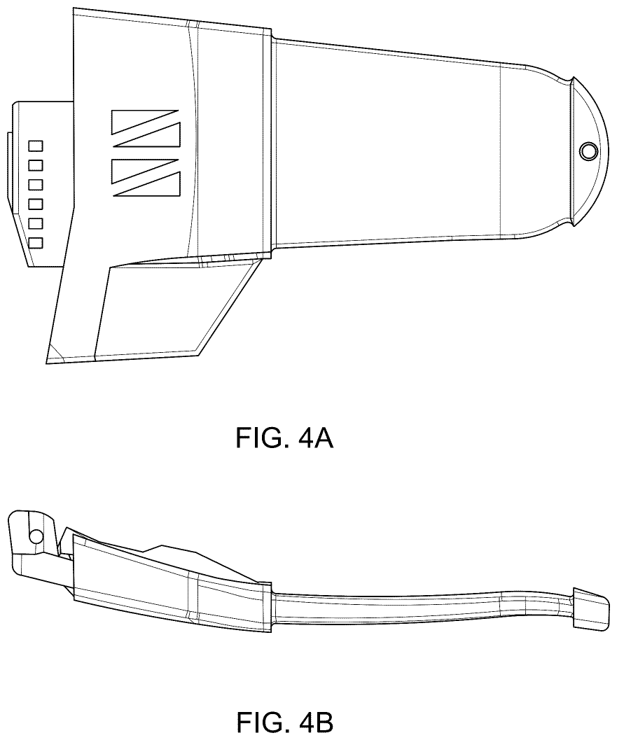

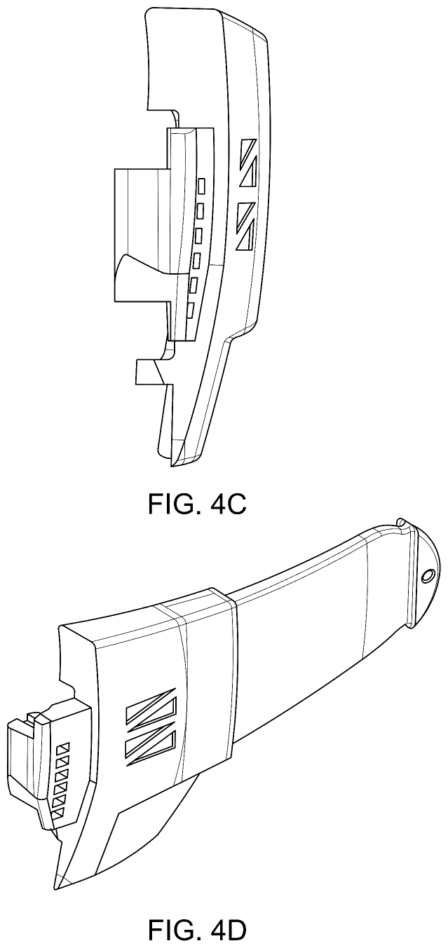

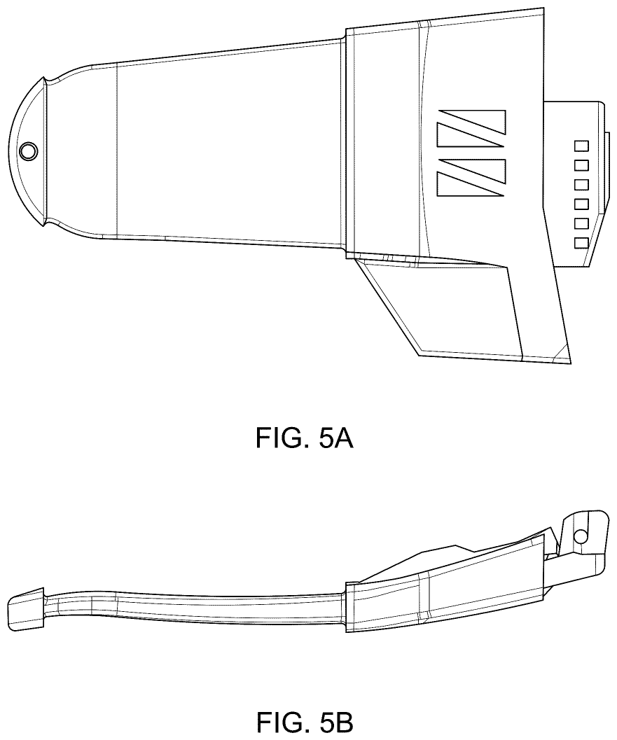

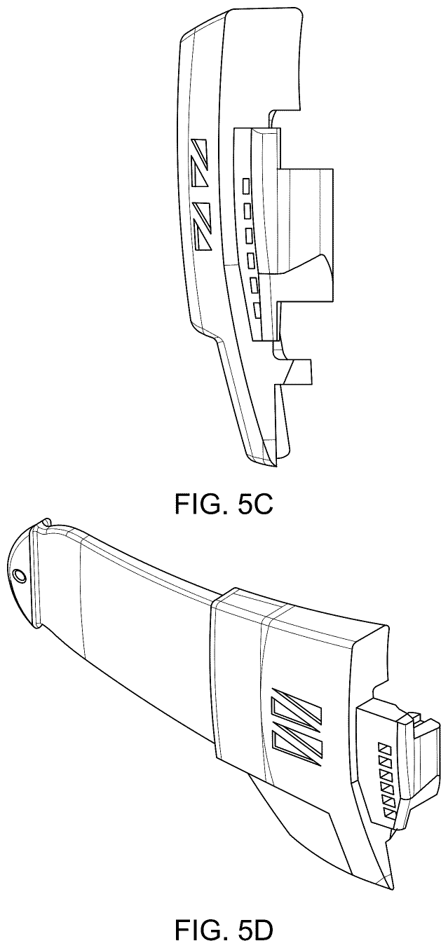

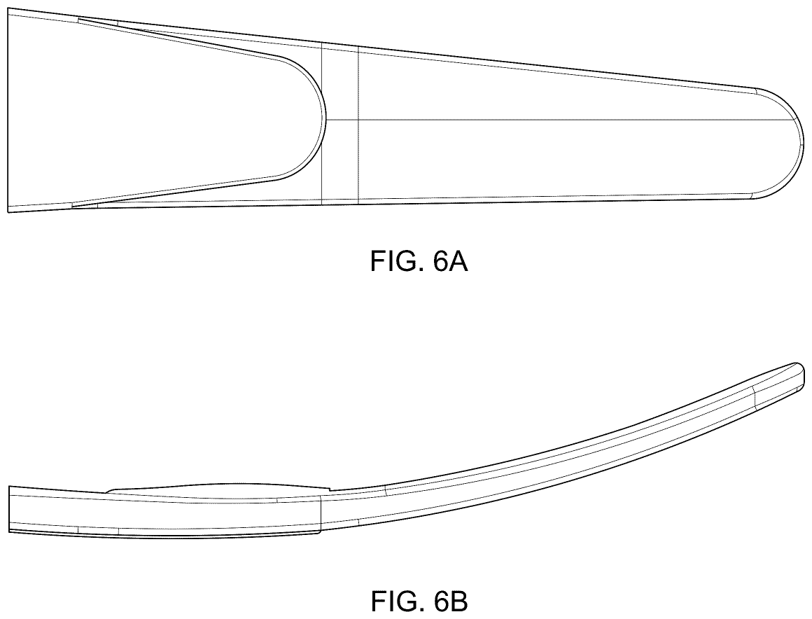

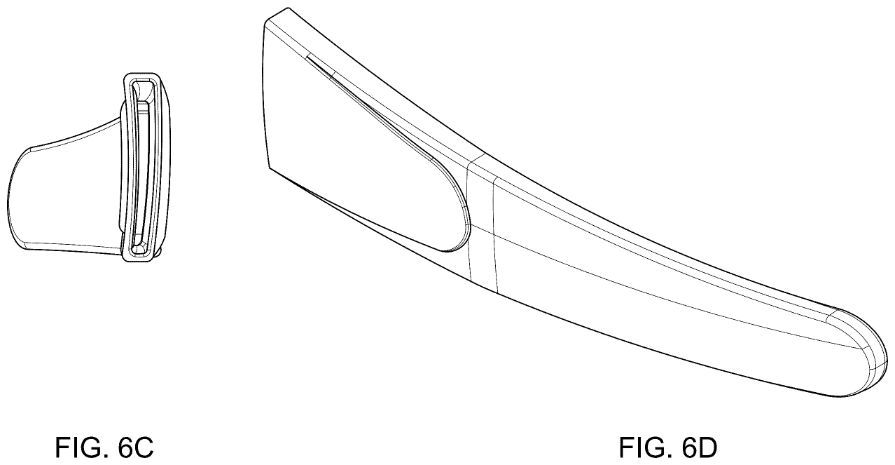

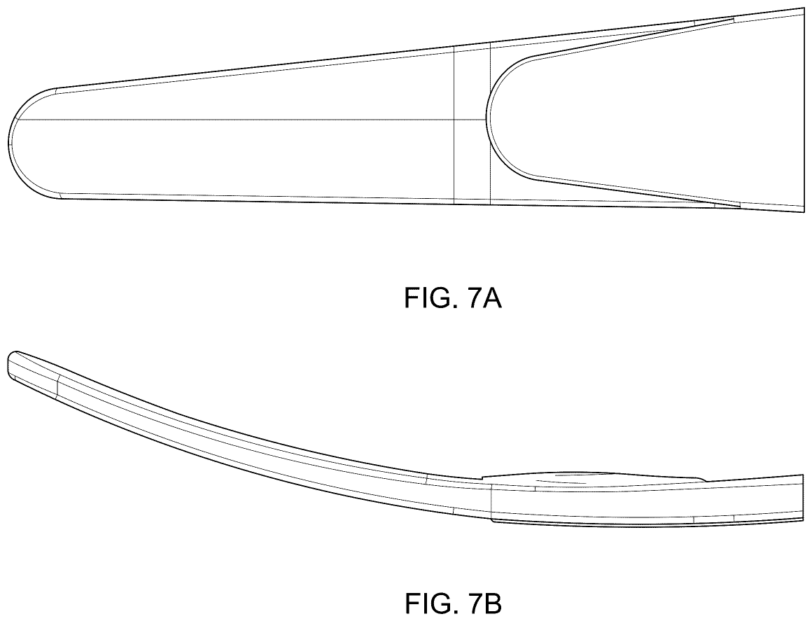

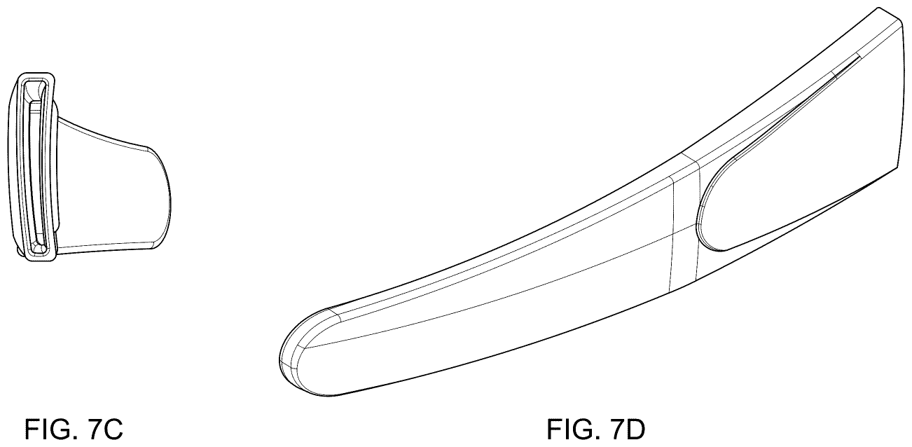

FIGS. 3-7 illustrate additional examples of this invention and its components. FIG. 3 shows an example of a front frame portion. FIGS. 4-5 show a left and right side of a temple portion embodiment of this invention. FIGS. 6-7 show a left and right side of a temple extension embodiment of this invention that can fit over a temple portion (e.g., like a temple portion as shown in FIGS. 4-5).

Many people that require shorter frame temple sunglasses will be able to use this new invention. One example is a person wearing headgear, such as a helmet, including a motorcycle rider who wears a safety helmet. Such an individual who wears a motorcycle helmet may find wearing sunglasses with long frame temples that go over the ears to be very uncomfortable due to the tight fit of the helmet placing pressure on the ears. Having short frame temples that do not reach the ears and only rest on the wearer's temples, will be much more tolerable. In sports, in which safety helmets are required such as in American football, the athlete may much rather have sunglasses that rest on the temples rather than on the ears. Soldiers that wear helmets and need to wear sunglasses for sun protection or for vision correction, may prefer sunglasses or frames that rest on the temples rather than on the ears. On other occasions, a wearer may want to have the longer frame temples and may believe they are more secure and less likely to fall or be taken off when jarred.

### Other Uses or Applications for This Invention

While this invention is described as applying to sunglasses as an example, it can also be applied to other eyewear, including eyewear with corrective lenses, or eyewear for safety or other purposes.

The relatively strong and/or adequate (i.e., to hold in place as desired) tension mechanism employed in embodiments of this invention also can be utilized for example in large VR headsets, including those that have previously relied on headbands to keep the headsets on the user's head. Having such a strong and/or adequate tension mechanism employed in such sets may be more beneficial in making the VR head set much smaller and more streamlined and more like wearing sunglasses.

The subject matter of this disclosure was described with reference to several examples (e.g., FIGS. 1-7). These examples are provided for the purpose of illustration only, and the subject matter is not limited to these examples, but rather encompasses all variations which are evident as a result of the teaching provided herein.

### Other Embodiments

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. Eyewear for a wearer to wear on the wearer's head, the eyewear comprising,
(a) two lenses, each lens for one of the wearer's eyes to look through when the eyeglasses are worn,
(b) one frame comprising,
(i) a front frame portion for holding each of the lenses in front of one of the wearer's eyes, the front frame portion having a left side and a right side,
(ii) two removeable temple portions, one temple portion for the left side of the wearer's head and one temple portion for the right side of the wearer's head, each temple portion extending from the front frame portion to at least in front of the wearer's ear, and
(iii) two connectors that are attached to the front frame portion, wherein one connector is attached to the left side of the front frame portion and one connector is attached to the right side of the front frame portion, wherein each connector can be inserted into one of the removeable temple portions to attach the removeable temple portion to the front frame portion, wherein each connector has a button that can be pushed when the connectors are attached to the removeable temple portions to remove the removeable temple portions from the front frame portion, and wherein the connectors provide tension to the removeable temple portions against the wearer's head to hold the eyeglasses in place on the wearer's head.

2. The eyewear of claim 1 wherein the eyewear is sunglasses and each of the lens prevents light from damaging and/or discomforting the eyes.

3. The eyewear of claim 1 wherein the eyewear is safety glasses and each of the lens prevents projectiles from damaging and/or discomforting the eyes.

4. The eyewear of claim 1 further comprising two temple extensions, each temple extension being capable of fitting over each of the removeable temple portions to extend the frame over more of the wearer's head.

5. The eyewear of claim 1, wherein the connectors further comprise cams and springs that provide the tension to the removeable temple portions against the wearer's head.

6. A method of holding eyeglasses on a wearer's head, wherein the eyeglasses comprise a right temple portion and a left temple portion that attach to the eyeglasses by a first connector and a second connector, the method comprising:
a. placing the eyeglasses on the wearer's head;
b. applying tension to the temple portions of the eyeglasses to the wearer's head by the first connector that attaches to the right temple portion and the second connector that attaches to the left temple portion, wherein the tension is provided by cams and springs, and the tension is provided to the wearer's head in front of the wearer's ears.
